(19) United States
(12) Patent Application Publication
(10) Pub. No.: US 2007/0071316 A1
(43) Pub. Date: Mar. 29, 2007

(54) Image correcting method and image correcting system

(75) Inventor: Masahiro Kubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/527,626

(22) Filed: Sep. 27, 2006

(30) Foreign Application Priority Data
Sep. 27, 2005 (JP) 2005-279451

(51) Int. Cl. G06K 9/00

(52) U.S. Cl. 382/162

(57) ABSTRACT

The image correcting method apparatus extract face regions of persons in an image inputted using image data, calculate correction amounts with respect to a predetermined target color for the extracted face regions, respectively, display the image on a display unit, as well as show the extracted face regions in the image displayed on the display unit, receive a selection instruction for selecting at least one of the face regions to be used for determining an entire image correction amount, determine the entire image correction amount by using a single correction amount or merging two or more correction amounts for the selected at least one of the face regions and correct the image for color and/or density by using the entire image correction amount. The image correcting system includes the image correcting apparatus, the display unit and an instruction input apparatus for inputting an instruction to the image correcting apparatus.

The entire content of a literature cited in this specification is incorporated herein by reference.

### BACKGROUND OF THE INVENTION

The present invention belongs to the field of image processing, and more specifically to a correcting system and a correcting method for correcting an image on which persons are shot so that their faces have appropriate colors and densities.

When producing photographic prints from digital image data obtained through shooting with a digital camera or digital image data obtained by photoelectrically reading an image shot on a photographic film, the image (image data) is subjected to correction so that the shot image is reproduced to have appropriate colors and densities. Particularly, in the case of an image on which persons are shot, it is important that skin colors of the persons be finely reproduced.

The image processing method focusing on the skin color of a person is exemplified by a method in which a face region of the person which was automatically extracted from image data is corrected so as to achieve a target range of density or a target chromaticity.

In the conventional photographic printing through so-called direct exposure (i.e., by exposing a photosensitive material (printing paper) while projecting an image shot in a photographic film thereon), there has been known a technology in which density data of a person's face is extracted, and an exposure amount is determined based on the extracted density data of the person's face so that the person's face is reproduced at a target density.

In the case where many faces are shot in one image in the above methods, it is considered that the average value of the densities of all faces is corrected to match with the target value.

However, colors and densities of persons' faces vary among individuals or races. Thus, in the case where there is a face which is greatly different in color and density from other faces photographed in one image, when the simple average value of densities of all the faces in one image is used as an entire face density to correct each face, there is a problem in that no face in the image can be finished at appropriate densities.

For solving this problem, there has been proposed a method in which when the difference between the maximum value and the minimum value of densities determined in the regions judged as person's face regions exceeds a predetermined value, the face regions are classified into proper density groups based on the determined densities, and at least one of the density groups is automatically selected so as to determine the exposure amount of a copying material based on the selected density group (refer to JP 6-160994 A).

### SUMMARY OF THE INVENTION

However, in the method in JP 6-160994 A, there is a case where a principal person's face that needs to be properly finished is not included in the selected density group, and an image satisfying the needs of a user or a customer cannot be outputted.

Further, in the method in JP 6-160994 A, the face regions of persons are classified into the density groups so that each group has a peak hue value in a histogram. Therefore, although it is possible to classify face images whose hue values are obviously different from one another such as those of the Caucasian race and the Negroid race, it is impossible to perform fine classification based on, for example, individual differences in a single race. Thus, in the case where the shot image contains a face whose skin color is different from the standard skin color of the same race (e.g., a face with white face powder applied thereon as in a bride, and a suntanned face), the facial color of the principal person's face which is not the standard skin color and the standard facial color cannot be finished to have appropriate colors and densities.

Further, in the method in JP 6-160994 A, an image in which only Negroid persons are shot cannot be distinguished from another image in which only Caucasian persons are shot, so that it is always impossible to finish all the images properly.

An object of the present invention is to solve the problems of the above described conventional technique, and to provide an image correcting method capable of obtaining an image in which persons are shot and their facial colors are corrected in a proper range even in the case where they are different from each other, and is also appropriately corrected at the request of a user or a customer.

Another object of the present invention is to provide an image correcting system to implement the image correcting method.

In order to solve the above problems, the present invention provides an image correcting method including:

extracting face regions of persons in an image inputted using image data;

calculating correction amounts with respect to a predetermined target color for the extracted face regions, respectively;

displaying the image on a display unit, as well as showing the extracted face regions in the image displayed on the display unit;

receiving a selection instruction for selecting at least one of the face regions to be used for determining an entire image correction amount;

determining the entire image correction amount by using a single correction amount or merging two or more correction amounts for the selected at least one of the face regions; and

correcting the image for color and/or density by using the entire image correction amount.

Preferably, the image correcting method further including:

classifying the extracted face regions into groups based on the correction amounts calculated for the face regions,

wherein the face regions are shown in groups when the image is displayed on the display unit, and the selection instruction for selecting the at least one of the face regions to be used for determining the entire' image correction amount is received group by group.

Further, preferably, the image correcting method further including:

receiving an instruction for setting respective levels of importance for selected two ore more of the face regions,

wherein the two or more correction amounts of the selected two or more of the face regions is weighted for merging the respective two or more correction amounts for the selected two or more of the face regions according to the set respective levels of importance therefore.

Further, preferably, the image correcting method further including:

receiving an instruction for setting a target color for reproducing a face or faces of the selected at least one of the face regions,

wherein the one or more correction amounts of the selected at least one of the face regions or the entire image correction amount is adjusted according to the target color set for color reproduction.

Furthermore, in order to solve the above problems, the present invention provides an image correcting system including:

an image correcting apparatus for correcting for appropriate color and/or density face regions in an image inputted using image data;

a display apparatus for displaying the image inputted to the image correcting apparatus; and

an instruction input apparatus for inputting an instruction to the image correcting apparatus,

wherein the image correcting apparatus includes:
a face region extracting unit for extracting the face regions of persons in the image;
a correction amount calculation unit for calculating correction amounts with respect to a predetermined target color for the extracted face regions, respectively;
a correction amount determining unit for determining an entire image correcting amount by using a single correction amount or merging two or more correction amounts in at least one of the face regions that has been selected with the instruction input apparatus;
an image correction unit for correcting the image for color and/or density by using the entire image correction amount determined by the correction amount determining unit,

wherein the extracted face regions are shown in the image displayed on the display unit, and the at least one of the face regions to be used for determining the entire image correction amount is selected from among the extracted face regions shown in the image displayed on the display unit through an input of an selection instruction with the instruction input apparatus.

Preferably, the image correcting system further including:

a grouping processing unit for classifying the face regions extracted by the face region extracting unit into groups based on the correction amounts calculated for the face regions by the correction amount calculation unit,

wherein the display apparatus displays the face regions in groups when then image is displayed, and

the instruction input apparatus inputs the selection instruction for selecting the at least one of the face regions to be used for calculating the entire image correction amount to the image correction apparatus group by group.

Having the above configuration, the present invention is capable of obtaining an image in which persons are shot and their facial colors are corrected in a proper range even in the case where they are different from each other, and is also appropriately corrected at the request of a user or a customer.

### BRIEF DESCRIPTION OF THE DRAWINGS

In the accompanying drawings:

FIG. 1 is a block diagram showing an embodiment of an image correcting system according to the present invention;

FIG. 2 is a view showing one example of a display screen;

FIG. 3 is a flow chart of image correction processing performed in the image correcting system in FIG. 1;

FIG. 4 is a block diagram showing another embodiment of the image correcting system according to the present invention;

FIG. 5 is a view showing another example of the display screen; and

FIG. 6 is a flow chart of image correction processing performed in the image correcting system in FIG. 3.

### DETAILED DESCRIPTION OF THE PREFERRED EMBODIMENTS

An image correcting method and an image correcting system according to the present invention will be described below based on the preferred embodiments with reference to the accompanying drawings.

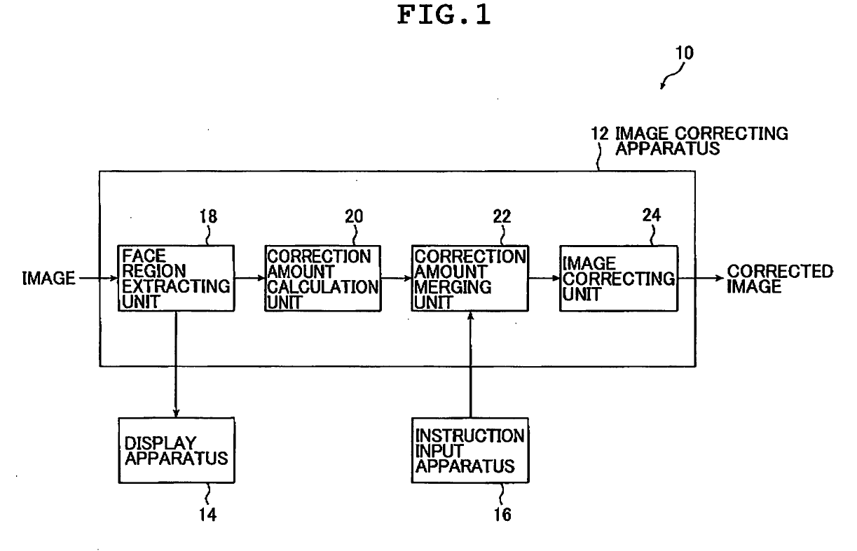

FIG. 1 is a block diagram showing an embodiment of an image correcting system according to the present invention implementing an image correcting method of the present invention.

An image correcting system 10 shown in FIG. 1 extracts face regions of persons in an inputted image, properly corrects the face regions for color and density, and outputs the corrected image to a photo printer or the like which performs digital exposure.

The image correcting system 10 includes an image correcting apparatus 12 for properly correcting face regions in an inputted image for color and density, a display apparatus 14 for displaying the image inputted to the image correcting apparatus 12, and the instruction input apparatus 16 for inputting instructions to the image correcting apparatus 12.

The display apparatus 14 is an image display apparatus including a monitor. A graphical user interface (GUI) using the display apparatus 14, and instruction input devices such as a keyboard, a mouse and a touch panel incorporated in the display apparatus 14, or a dedicated instruction input board may be employed for the instruction input apparatus 16.

The image correcting apparatus 12 includes a face region extracting unit 18, a correction amount calculation unit 20, a correction amount merging unit 22, and an image correcting unit 24. These components of the image correcting apparatus 12 can be each composed of hardware or software that executes predetermined arithmetic processing.

An image input machine, a print order receiver, and the like (hereinafter, collectively called “image input machine”) are directly or indirectly connected to the image correcting apparatus 12. The image input machine includes a media driver for reading out image data obtained through shooting with a digital camera or the like and from various media on which the image data is recorded, a network connection unit for obtaining image data through communication lines such as the Internet, a terminal for direct connection to digital imaging devices such as a digital camera and a camera-equipped cell phone, a scanner which photoelectrically reads the image shot in a photographic film to obtain image data. The image input machine is used to input the obtained image (image data) to the image correcting apparatus 12.

In the case where the image input machine received the image data from a digital camera or the like, in general, the digital camera or the like has already been performed on the image data the minimum image processing necessary for reproducing the image as it is, so that the image data may be directly inputted into the image correcting apparatus 12. On the other hand, in the case of image data read from a photographic film, the image data is inputted into the image correcting apparatus 12 after being subjected to normal image processing for reproducing the entire image almost properly.

The image which was inputted into the image correcting apparatus 12 is first sent to the face region extracting unit 18.

The face region extracting unit 18 extracts human face regions from one image which was inputted. The method of extracting the face regions is not specifically limited, and various known methods can be utilized, which include a method in which an area of pixels in a skin color range is extracted as a face region, and a method utilizing a shape pattern retrieval technique.

Also, the image inputted to the image correcting apparatus 12 is displayed on the monitor of the display apparatus 14, and the face regions extracted in the face region extracting unit 18 are shown in the displayed image.

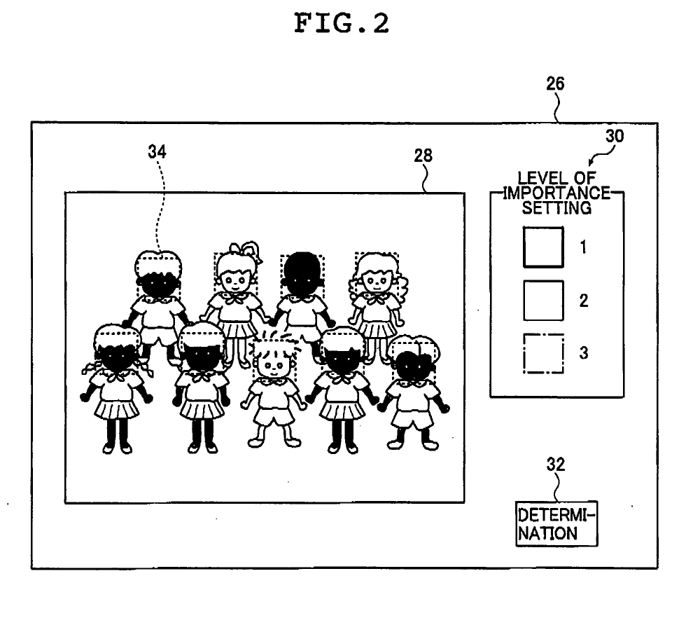

FIG. 2 shows one example of the display screen of the display apparatus 14. In an illustrated display screen 26, the inputted image is displayed in an image display region 28, and the extracted face regions are each surrounded with a face indicating frame 34 in the displayed image.

The correction amount calculation unit 20 calculates a correction amount with respect to a predetermined target color for each face region extracted by the face region extracting unit 18.

The target color has a target skin color value which is considered to be preferable in reproducing the image on a photographic print or on the display. The skin colors considered to be preferable when the image is reproduced vary among individuals depending upon various factors such as race, gender and age of a subject, whether or not a subject puts on makeup, and lighting. In the correction amount calculation unit 20, one of the skin colors varying among individuals (e.g., the skin color of a normal person in the region where the image correcting system 10 is used) is set as the default target color.

The correction amount calculation unit 20 calculates for each face region a correction amount which is used for making the color of the face region close to the target color, and sends the obtained results to the correction amount merging unit 22.

On the other hand, a user operates the instruction input apparatus 16 to input a selection instruction for instructing which face is to be used or is not to be used for calculating the entire image correction amount, of the face regions detected in the image displayed on the display apparatus 14.

The correction amount merging unit 22 merges the correction amounts of the face regions that were selected for calculating the entire image correction amount from the correction amounts of the face regions sent from the correction amount calculation unit 20 in response to the selection instruction inputted from the instruction input apparatus 16, thereby obtaining the entire image correction amount.

The thus obtained entire image correction amount is sent to the image correcting unit 24.

The image correcting unit 24 corrects the image for color and density based on the entire image correction amount which was obtained in the correction amount merging unit 22, and outputs the corrected image.

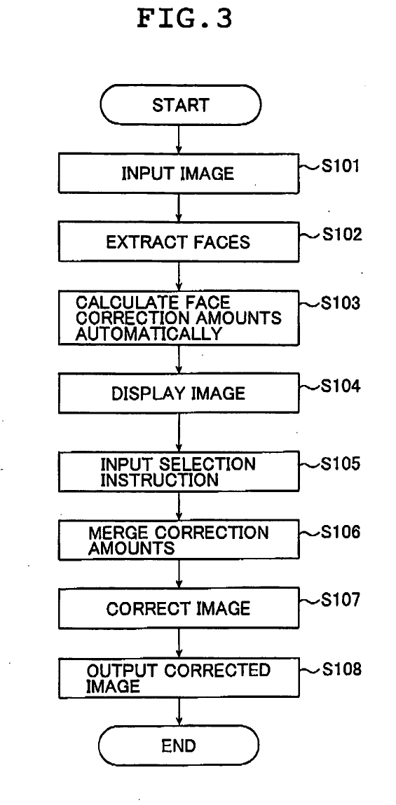

Next, the image correction processing performed in the image correcting system 10 is explained based on the flow chart shown in FIG. 3.

When the image is inputted into the image correcting apparatus 12 of the image correcting system 10 (Step S101), in the image correcting apparatus 12, the face region extracting unit 18 extracts human face regions from the image so as to detect all possible faces of the persons in the image (Step S102), the correction amount calculation unit 20 automatically calculates the correction amount for color and density for each face region extracted in the face region extracting unit 18 based on the predetermined target skin color value (Step S103), and the correction amount calculation unit 20 sends the calculated correction amounts to the correction amount merging unit 22.

The data on the position and size of each face region detected in Step S102, and the correction amount for each face region calculated in Step S103 are preferably stored temporarily in a not shown storage unit provided in the image correcting system 10 until the image is outputted.

The image correcting apparatus 12 composes the inputted image and figures (such as frames) indicating the faces detected in the image by the face region extracting unit 18, and displays them on the monitor of the display apparatus 14 (Step S104). For example, as shown in FIG. 2, the image inputted in the image display region 28 of the display screen 26 is displayed, and the face indicating frames 34 are shown in the image so as to surround the respective detected faces.

Whereby, a user (operator) can recognize the faces detected in the image.

The user who has checked the display screen 26 displayed on the display apparatus 14 operates the instruction input apparatus 16 to select one or more face regions to be used for calculating the entire image correction amount.

In the example shown in FIG. 2, there are a selection instruction section 30 and a determination button 32 beside the image display region 28 in the display screen 26. The user sets a frame 1 in the selection instruction section 30 for a face that is desired to be corrected to have a preset target color (i.e., a principal person whose facial color needs to be finished properly). The frame 1 can be set for one or more faces.

As in the illustrated example, the selection instruction section 30 may have multiple kinds of frames such as a frame 2 and a frame 3 in addition to the frame 1 as the selection instruction frames, so that it is-possible to rank and set the levels of importance of the faces.

Contrary to the above, the faces not used for calculating the entire image correction amount may be selected. For example, in the case where the skin color of the Mongoloid race is set as a target color, and a few faces that are different from many other faces of the Mongoloid race are taken in the image (e.g., a suntanned face, a painted face, or a face of another race (such as the Caucasian race or the Negroid race) that is significantly different from the normal face of the Mongoloid race in skin color), the few faces are designated not to be used for calculating the entire image correction amount.

After designating the faces not to be used for calculating the entire image correction amount, the determination button 32 is pushed, so that the inputted instruction is determined. Then, this instruction is inputted to the correction amount merging unit 22 from the instruction input apparatus 16 (Step S105).

Next, the correction amount merging unit 22 merges all correction amounts according to the user's instruction. That is, after receiving the instruction from the instruction input apparatus 16, the correction amount merging unit 22 merges the data on the correction amounts of the face regions designated to be used for calculating the entire image correction amount from among the correction amounts of all the face regions sent from the correction amount calculation unit 20, thereby calculating the entire image correction amount (Step S106).

Specifically, the average value of the correction amounts of the face regions selected by the instruction input apparatus 16 is calculated to be used as the entire image correction amount. In Step S105, the faces to be used for calculating the entire image correction amount are selected or the faces not to be used for calculating the entire image correction amount are removed, so that the faces that are greatly different from a normal face can be removed. Thus, a proper correction amount for the image can be calculated by simply averaging the correction amounts of the faces excluding the faces different from the normal face.

In the case where the levels of importance are set for the faces selected to be used for calculating the entire image correction amount, the correction amounts of the selected face regions are weighted according to the levels of importance set for the face regions and merged. In the case where the weight is already set, the weight is changed. Whereby, it is possible to adjust the facial color more finely.

In the case where only one face is selected for calculating the entire image correction amount, the correction amount of the selected one face is used as the entire image correction amount.

After the calculation of the entire image correction amount, the image correcting unit 24 corrects the image for color and density based on the entire image correction amount (Step S107), and the corrected image is outputted to a photo printer or the like (Step S108).

The corrected image outputted from the image correcting apparatus 12 is sent to the digital photo printer for print production. The corrected image may be sent to a display device or a recording device such as a media driver so as to display the image or store the image data.

After the image correction in Step S107, the operation may be returned to Step S104 so as to redisplay the corrected image on the display apparatus 14, and the correction amount merging unit 22 may be capable of receiving the input from the instruction input apparatus 16 in Step S105 so as to change the above selection instruction.

According to the image correcting system 10 in the present invention, the faces detected from the inputted image are displayed on the monitor of the display apparatus 14, and an operator can select the faces to be used or not to be used for calculating the entire image correction amount from the detected faces through selection instruction, so that it is possible to output an image satisfying the needs of a user or a customer.

Next, another embodiment of the image correcting system according to the present invention will be explained.

In the above embodiment, in the image correcting apparatus 12, a target facial color is predetermined, the correction amounts of the faces selected by the instruction input apparatus 16 are calculated and merged, and the image correction is performed so as to approach a certain target value for the selected faces.

On the other hand, in this embodiment, when the instruction as to which face region is to be selected from the image displayed on the display apparatus 14 is received from the instruction input apparatus 16 in the image correcting system 10 shown in FIG. 1, the designation of the face target color to be reproduced in the selected face region is also received, and the correction amount is adjusted according to the designated face target color.

That is, in Step S104 in FIG. 3, the display apparatus 14 displays the inputted image and detected faces, and also displays a sample image of typical facial colors beside any one of the selected faces. The sample image may be composed of plural face images with different facial colors or a color pallet including plural skin colors. With the sample image displayed, a user can easily select a suitable skin color.

A user looks at the image display screen 26 displayed on the display apparatus 14 to select a face or a color to be set as the target value from the sample image or the color pallet, and also select a face whose color is desirable to match with the target color from among the faces detected in the image to be processed. In Step S105, the instruction corresponding to the above selection instruction is inputted from the instruction input apparatus 16 into the correction amount merging unit 22.

Whereby, the target value for face reproduction can be changed depending upon the subject. For example, the target value of the facial color can be appropriately changed according to the race, gender, age, makeup color of the subject person (or the principal person) in the image, the environment (e.g., season, light source, and shade) of the place where the image is shot.

In Step S106, the correction amount merging unit 22 decides the entire image correction amount so that the faces selected to be processed have a target facial color. That is, the entire image correction amount obtained through the merging of the correction amounts of the selected faces (i.e., the average value or the weighted average value of color densities of the selected face regions) is adjusted so as to be close to the designated target color.

Alternatively, after the instruction input from the instruction input apparatus 16 in Step S105, the operation may be returned to Step S103 to adjust the correction amounts of faces calculated in the correction amount calculation unit 20 according to the target value inputted through the instruction input apparatus 16, and subsequently the operation may proceed to Step S106 to merge the adjusted correction amounts of the faces.

After obtaining the entire image correction amount as above, the image is corrected and outputted in the same manner as the above-described example.

Similarly to the above, after the correction in Step S107, the operation may be returned to Step S104 to redisplay the corrected image on the display apparatus 14, and the correction amount merging unit 22 may be capable of receiving the instruction input from the instruction input apparatus 16 in Step S105 so as to change the above selection instruction.

In this embodiment, a user can select a correction target person and a target color for reproducing the face of the correction target person, so that even if the target person's face is different in color from the preset target color (for example, standard skin color) because of the difference in race, gender, makeup color, or the like, the target person's face can be finished to have appropriate colors and densities. Further, for example, even if persons with different facial colors are shot on an image, they can be finished to have appropriate colors and densities.

Next, still another embodiment of the image correcting system according to the present invention will be explained.

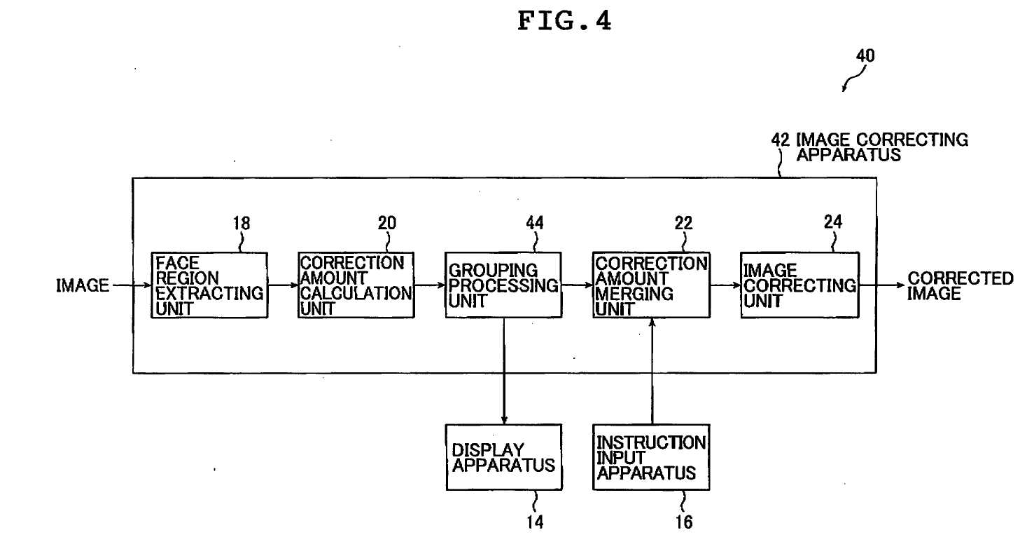

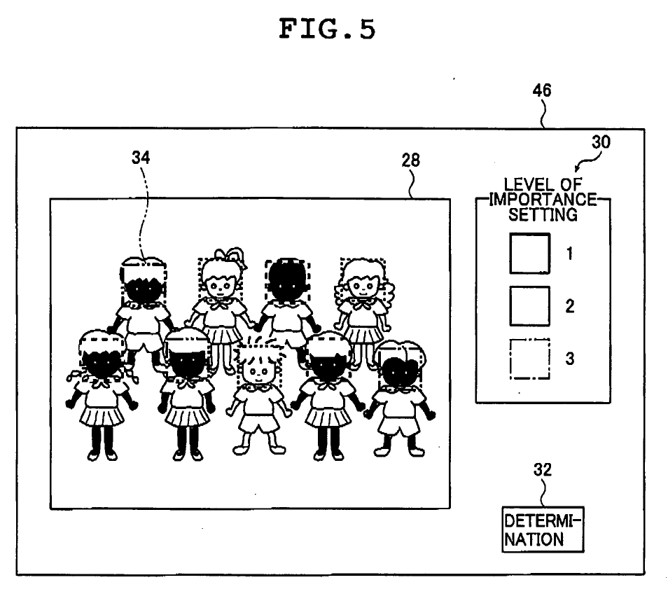

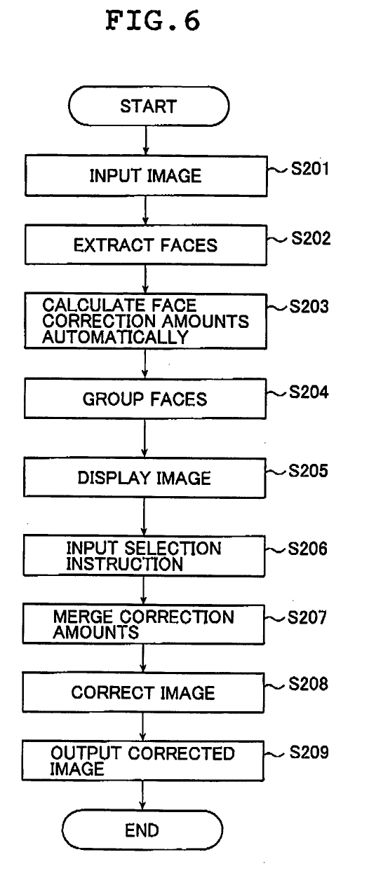

FIG. 4 is a block diagram showing the construction of an image correcting system 40 according to this embodiment of the present invention, FIG. 5 is an example of a display screen in the image correcting system 40 in FIG. 4, and FIG. 6 is a flow chart of the image correction processing performed in the image correcting system 40 in FIG. 4.

The construction of the image correcting system 40 in FIG. 4 is basically the same as that of the image correcting system 10 in FIG. 1 except that a grouping processing unit 44 is provided between the correction amount calculation unit 20 and the correction amount merging unit 22 in the image correcting apparatus 42, so that like components are denoted with like reference numerals, and the detailed description thereof will be omitted. Thus, different points are mainly explained below.

In the image correcting system 40, when an image is inputted into the image correcting apparatus 42 (Step S201), the face region extracting unit 18 extracts the face regions of persons in the image (Step S202), and the correction amount calculation unit 20 automatically calculates the correction amount for color and density for each face region extracted in the face region extracting unit 18 based on the predetermined target skin color value (Step S203).

The grouping processing unit 44 classifies the face regions extracted in the face region extracting unit 18 into one or more groups based on the correction amounts calculated by the correction amount calculation unit 20 (Step S204). Specifically, the face regions are classified into groups so that each group includes face regions having close correction amounts.

After the face regions have been classified into groups, the image correcting system 40 composes the inputted image and figures (for example,. frames) indicating faces detected in the image, and displays them on the monitor of the display apparatus 14 (Step S205). At this time, the face regions are displayed in groups.

For example, in the case of a group photograph in which persons of the Mongoloid race, the Negroid race, and the Caucasian race are shot, the grouping processing unit 44 classifies their faces into the groups of the Mongoloid race, the Negroid race, and the Caucasian race. The display apparatus 14 displays the image in the image display region 28 of a display screen 46, and also shows frames with different colors or line types for the respective groups of the face regions as the face indicating frames 34 each surrounding a detected face as shown in FIG. 5.

A user who checked the display screen 46 displayed on the display apparatus 14 operates the instruction input apparatus 16 to select face regions used for calculating the entire image correction amount on a group basis.

In the case where plural groups are set, the levels of importance of the faces may be ranked and set on a group basis.

Alternatively, the faces that are not used for calculating the entire image correction amount may be selected on a group basis.

After the group selection has been finished, the inputted instruction is determined by pressing the determination button 32, and the instruction is inputted into the correction amount merging unit 22 from the instruction input apparatus 16 (Step S206).

Similarly to the above described example, the correction amount merging unit 22 merges the correction amounts of the faces calculated in the correction amount calculation unit 20 according to the instruction inputted by a user from the instruction input apparatus 16 (Step S207). In this embodiment, since the faces are selected on a group basis, the entire image correction amount is calculated as above using the correction amount(s) of one or more faces of the selected group.

After the entire image correction amount has been calculated, the image correcting unit 24 corrects the image for color and density based on the entire image correction amount (Step S208), and the corrected image is outputted to a photo printer or the like (Step S209).

In this embodiment, plural faces shot in one image are classified into groups each including face regions that have close correction amounts or are similar in color and density and displayed in groups, so that the relation among the facial colors can be easily understood, thereby making it easy to select a reference face for correction.

In the above explanation, the correction processing is performed image by image in the image correcting system 10 or 40, however, the present invention is not limited thereto. In the above various embodiments, the correction amounts of plural images may be merged into a single correction amount so that images are corrected with the single correction amount.

In this case, similarly to the above, faces in each of images are extracted to calculate the correction amounts of the faces, and the correction amounts of the faces in each of the images are merged, after which the resulting correction amounts of the images are further merged to be used for correction of every image.

In the image correcting system 10 or 40 of the present invention, in the case where the difference between the entire image correction amount which was calculated by focusing only on face regions for appropriately finishing the face regions and the correction amount which was calculated in a common method by focusing on areas excluding the face regions extracted from an image or an entire image is larger than a specified value, a user may be notified by displaying on the display apparatus 14 or by emitting a sound from the image correcting apparatus 12, so that the user can select which correction amount is adopted.

When the above two correction amounts are greatly different from each other, the image may be peculiar, such as an image with extremely uneven or unbalanced facial color. In this case, the image may not be corrected appropriately with the correction amount obtained by only focusing on the face regions. Therefore, in this case, the system recommends the user to apply a correction amount with which the background is corrected for color and density to obtain a standard value, so that the image is prevented from being corrected inappropriately.

The image correcting method and the image correcting system according to the present invention have been explained above in detail, however, the present invention is not limited the above various embodiments, and various improvements and modifications are possible without departing from the scope of the present invention.

What is claimed is:

1. An image correcting method comprising:
extracting face regions of persons in an image inputted using image data;
calculating correction amounts with respect to a predetermined target color for said extracted face regions, respectively;
displaying said image on a display unit, as well as showing said extracted face regions in said image displayed on said display unit;
receiving a selection instruction for selecting at least one of said face regions to be used for determining an entire image correction amount;
determining said entire image correction amount by using a single correction amount or merging two or more correction amounts for said selected at least one of said face regions; and
correcting said image for color and/or density by using said entire image correction amount.

2. The image correcting method according to claim 1, further comprising:
classifying said extracted face regions into groups based on said correction amounts calculated for said face regions,
wherein said face regions are shown in groups when said image is displayed on said display unit, and said selection instruction for selecting said at least one of said face regions to be used for determining said entire image correction amount is received group by group.

3. The image correcting method according to claim 1, further comprising:
receiving an instruction for setting respective levels of importance for selected two ore more of said face regions,
wherein said two or more correction amounts of said selected two or more of the face regions is weighted for merging said respective two or more correction amounts for said selected two or more of said face regions according to said set respective levels of importance therefore.

4. The image correcting method according to claim 1, further comprising:
receiving an instruction for setting a target color for reproducing a face or faces of said selected at least one of the face regions,
wherein said one or more correction amounts of said selected at least one of said face regions or said entire image correction amount is adjusted according to said target color set for color reproduction.

5. An image correcting system comprising:
an image correcting apparatus for correcting for appropriate color and/or density face regions in an image inputted using image data;
a display apparatus for displaying said image inputted to said image correcting apparatus; and
an instruction input apparatus for inputting an instruction to said image correcting apparatus,
wherein said image correcting apparatus includes:
a face region extracting unit for extracting said face regions of persons in said image;
a correction amount calculation unit for calculating correction amounts with respect to a predetermined target color for said extracted face regions, respectively;
a correction amount determining unit for determining an entire image correcting amount by using a single correction amount or merging two or more correction amounts in at least one of said face regions that has been selected with said instruction input apparatus;
an image correction unit for correcting said image for color and/or density by using said entire image correction amount determined by said correction amount determining unit,
wherein said extracted face regions are shown in said image displayed on said display unit, and said at least one of said face regions to be used for determining said entire image correction amount is selected from among said extracted face regions shown in said image displayed on said display unit through an input of an selection instruction with said instruction input apparatus.

6. The image correcting system according to claim 5, further comprising:
a grouping processing unit for classifying said face regions extracted by said face region extracting unit into groups based on said correction amounts calculated for said face regions by said correction amount calculation unit,
wherein said display apparatus displays said face regions in groups when said image is displayed, and
said instruction input apparatus inputs said selection instruction for selecting said at least one of said face regions to be used for calculating said entire image correction amount to said image correction apparatus group by group.
